(19) United States
(12) Patent Application Publication
(10) Pub. No.: US 2012/0016181 A1
(43) Pub. Date: Jan. 19, 2012

(54) Fully or Partially Implantable Hearing System

(75) Inventors: Stefan Menzl, Jona (CH); Achim Kitschmann, Lausanne (CH); Gerard Loquet, Fribourg (CH)

(73) Assignee: ADVANCED BIONICS AG, Zug (CH)

(21) Appl. No.: 13/259,360

(22) PCT Filed: Mar. 24, 2009
(86) PCT No.: PCT/EP2009/053452

§ 371 Date: Sep. 23, 2011

(51) Int. Cl. H04R 25/00

(52) U.S. Cl. 600/25

(57) ABSTRACT

There is provided an at least partially implantable hearing system comprising a microphone assembly for capturing audio signals from ambient sound; an audio signal processing unit for processing the audio signals captured by the microphone assembly; an implantable main electromechanical output transducer for direct mechanical stimulation of the cochlea according to the audio signals processed by the audio signal processing unit; an implantable box having a central part and an open flange for penetrating through the cochlear wall into the perilymph fluid, wherein the inner cross section of the central part is larger than the inner cross section of the flange; and wherein the electromechanical output transducer is for acting on the perilymph fluid in the central part of the box through a port provided at the box. The box comprises at least one of a port for an implantable auxiliary electromechanical output transducer for acting on the perilymph fluid in the central part of the box, a port for drug application into the perilymph fluid in the central part of the box, a port for taking out perilymph fluid from the central part of the box, a port for applying optical stimuli to the perilymph fluid of the cochlea, and a port for at least one sensor for sensing at least physical or chemical parameter of the perilymph fluid in the central part of the box.

The invention relates to a fully or partially implantable hearing system for direct mechanical stimulation of the cochlear.

Hearing systems for direct stimulation of the cochlea are known, for example, from U.S. Pat. No. 6,629,923 B2, U.S. Pat. No. 5,951,601, U.S. Pat. No. 5,772,575 and US 2003/0055311 A1. The principle basic to such systems is to generate a volume displacement of the cochlear fluid via a stimulator which may comprise a moving piston or a vibrating membrane. For implanting such stimulator (actuator), the cochlear is opened via stapedectomy, stapedotomy or cochleostomy, and the stimulator is introduced into this fenestration. Hereby space is always a challenge, since the space available around the cochlea and the middle ear is very limited. There is also a danger of damaging the cochlear structure, when the actuator is introduced too deep.

U.S. Pat. No. 5,411,467 relates to an implantable hearing system comprising a modified membrane actuator, wherein the membrane is provided at the end of a tube filled with liquid, the tube communicating with a chamber filled with liquid which is vibrated by a driven membrane provided within the chamber. By using such vibrating liquid volume, an optimised adaptation of the mechanical impedance with regard to the fluid within the cochlea is achieved. The tube may be made of flexible material.

WO 2008/077943 A2 relates to an implantable hearing system comprising a box comprising a central portion and a flange portion, wherein the flange portion penetrates through the cochlear wall and is open at one end towards the interior of the cochlea, while the other end of the flange portion communicates with the central portion of the box. The central portion comprises a vibrating actuator acting on the fluid within the central portion. After implantation the flange portion and the central portion of the box are filled with perilymph fluid from the cochlea, so that the actuator can directly act on the perilymph fluid. It is known that the perilymph fluid missing in the cochlea due to the implantation of the box is substituted by the perilymph system by some kind of “re-fill” process. Thereby the original fluid pressure in the cochlear will be restored. A similar hearing system is known from WO 2007/023164 A1.

It is an object of the invention to provide for an at least partially implantable hearing system for direct mechanical stimulation of the cochlea, wherein the functionality of the interface to the cochlea should be improved.

According to the invention, this object is achieved by a hearing system as defined in claim 1.

The invention is beneficial in that, by providing an implantable box communicating with the perilymph fluid of the cochlea with at least one of a port for an implantable auxiliary electromechanical output transducer for acting on the perilymph fluid in the box, a port for drug application into the perilymph fluid in the box, a port for taking out perilymph fluid from the box, a port for applying optical stimuli to the perilymph fluid and a port for at least one sensor for sensing at least one physical or chemical parameter of the perilymph fluid in the box, additional beneficial functions can be added to the basic function of the box, namely to serve as an interface for an implantable main electromechanical output transducer for direct mechanical stimulation of the cochlea.

Preferred embodiments of the invention are defined in the dependent claims.

In the following, examples of the invention will be illustrated by reference to the attached drawings, wherein:

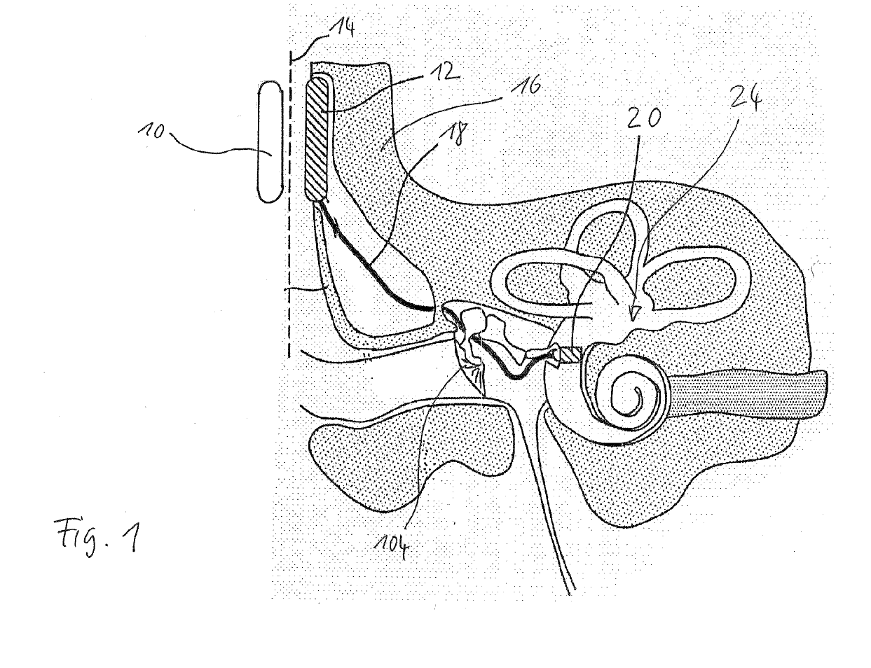

FIG. 1 is a cross-sectional view of an example of a hearing system according to the invention after implantation;

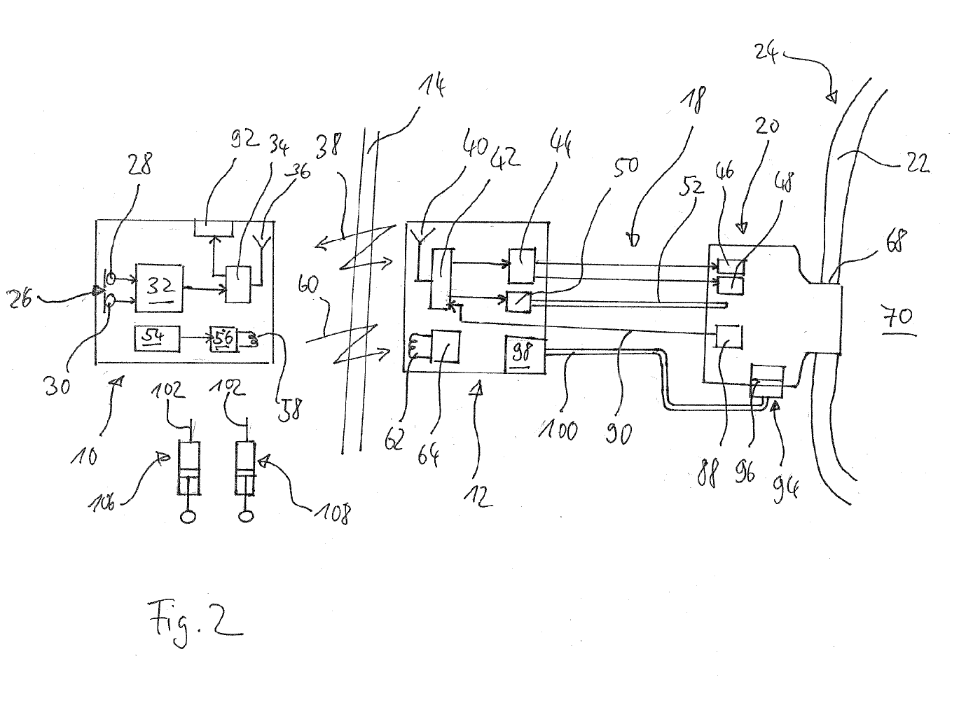

FIG. 2 is a block diagram of the system of FIG. 1;

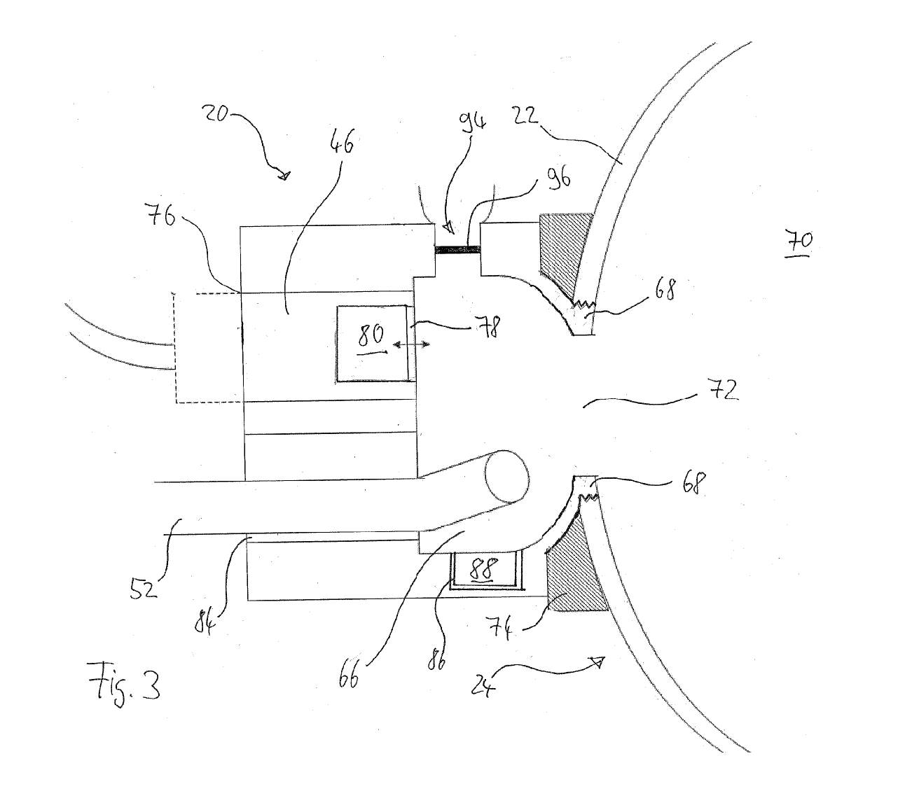

FIG. 3 is a schematic cross-sectional view of a first example of the cochlear box used in the system of FIGS. 1 and 2; and

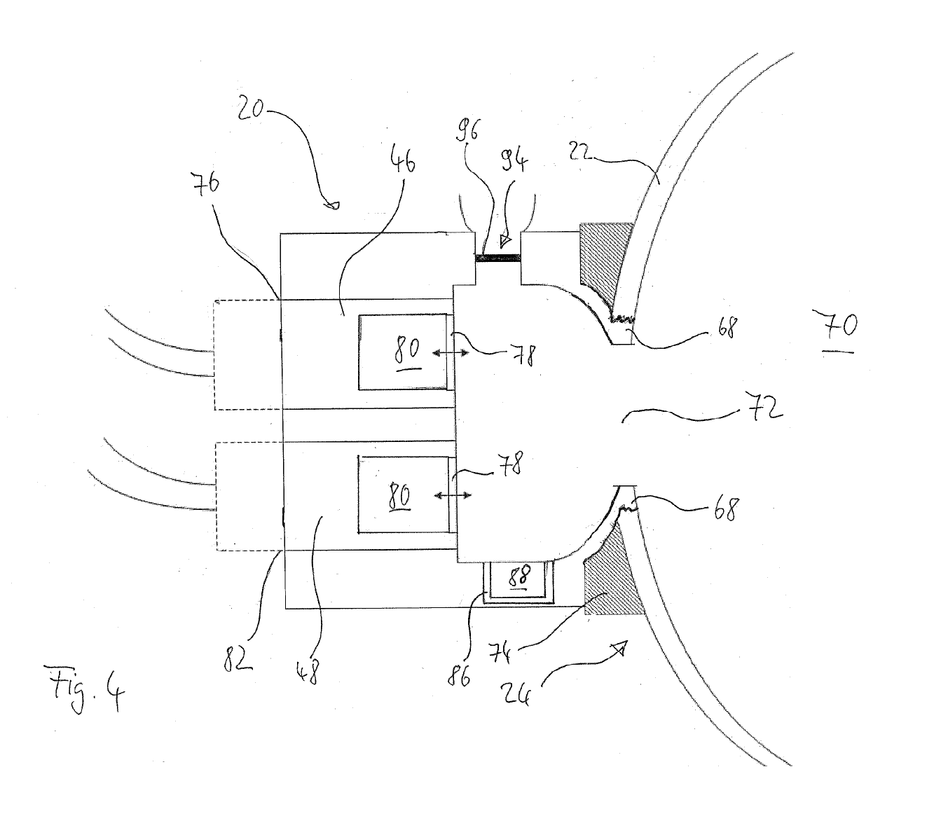

FIG. 4 is a second example of the cochlear box used in the system of FIGS. 1 and 2.

FIG. 1 shows a cross-sectional view of the mastoid region, the middle ear and the inner ear of a patient after implantion of an example of a hearing system according to the invention, wherein the hearing system is shown only schematically. The system comprises an external unit 10 which is worn outside the patient's body at the patient's head and an implantable unit 12 which is implanted under the patient's skin 14, usually in an artificial cavity created in the user's mastoid 16. The implantable unit 12 is connected via a cable assembly 18 to a box 20 which is implanted at the wall 22 of the cochlear 24. The external unit 10 is fixed at the patient's skin 14 in a position opposite to the implantable unit 12, for example by magnetic forces created by cooperating fixation magnets provided in the external unit 10 and the implantable unit 12, respectively (these fixation magnets are not shown in FIG. 1).

An example of a block diagram of the hearing system of FIG. 1 is shown in FIG. 2. The external unit 10 comprises a microphone arrangement 26 comprising at least two spaced-apart microphones 28 and 30 for capturing audio signals from ambient sound which are supplied to an audio signal processing unit 32 where they undergo, for example, acoustic beamforming. The audio signals processed by the audio signal processing unit 32 are supplied to transmission unit 34 connected to a transmission antenna 36 in order to enable transcutaneous transmission of the processed audio signals via an inductive link 38 to the implantable unit 12 which comprises a receiver antenna 40 connected to a receiver unit 42 for receiving the transmitted audio signals. The received audio signals are supplied to a driver unit 44 which drives at least one actuator (i.e. electromechanical output transducer) 46; in addition a second actuator 48 is shown in FIG. 2. The received audio signals also may be supplied to an optical driver 50 which supplies light signals corresponding to the received audio signals into an optical fibre 52.

The external unit 10 comprises a power supply 54, which may be a replaceable or rechargeable battery, a power transmission unit 56 and a power transmission antenna 58 for transmitting power to the implantable unit 12 via a wireless power link 60. The implantable unit 12 comprises a power receiving antenna 62 and a power receiving unit 64 for powering the implanted electronic components with power received via the power link 60. Preferably, the audio signal antennas 36, 40 are separate from the power antennas 58, 62, in order to optimize both the audio signal link 38 and the power link 60. However, if a particularly simple design is desired, the antennas 36 and 58 and the antennas 40 and 62 could be physically formed by a single antenna, respectively.

The box 20 comprises a central part 66 and an open flange 68 which penetrates through the cochlear wall 22 into the perilymph fluid 70, wherein the inner cross-section of the central part 66 is larger than the inner cross-section of the flange 68.

The box 20 may be implanted in the following manner. After a mastoidectomy, the best location for the box 20 is identified. Then a fenestration of the cochlear wall 22 is performed by stapedectomy, stapedotomy, cochleostomy or removing the round window. The respective hole 72 through the cochlear wall 22 may be created by mechanical drilling or by using a surgical laser. Then the flange 68 of the box 20 is inserted into the opening 72. To this end, the flange 68 may be provided with a thread at its outer surface, so that it can be screwed into the opening 72. If necessary, the box 20 is additionally fixed at the cochlear wall 22, for example by applying bone cement 74 at the surface of the cochlear wall 22 surrounding the opening 72. The additional fixation by the bone cement 74 may be omitted, if the fixation provided by the flange 68 is already sufficient. Rather than using a bone cement 74, an appropriate glue may be used. According to a further variant, the box 20 may be fixed to the cochlear wall 22 by clamps. In any case, it is important to obtain a fluid connection of the box 20 to the intertior of the cochlea 24.

The housing of the box 20 may comprise an outer structure, such as a thread, appropriate for coupling the box 20 to a tool (not shown) used for placing the box 20 at its position at the cochlear wall 22.

After implantation, the central part 66 and the flange 68 of the box 20 will be filled with perilymph fluid 70. However, this volume of the perilymph fluid 70 withdrawn from the cochlear will be replaced by the perilymph system, so that finally the artificial extra-cochlear volume within the box 20 will be completely filled with the perilymph fluid 70, and thus will become part of the cochlear fluid system, while the original fluid pressure within the cochlear is restored due to the known “re-fill” effect.

The central part 66 of the box 20 may have the geometry of a tube or a can. The housing of the box 20 may be realized as a metallic, ceramic or plastic housing.

According to the embodiments of FIGS. 3 and 4, the box 20 comprises a port 76 for the electromechanical output transducer 46 for acting on the perilymph fluid 70 in the central part 66 of the box 20. The output transducer 46 comprises a vibrating or reciprocating element 78, such as a driven piston or a driven membrane, which acts directly on the perilymph fluid 70. The element 78 may be driven by a piezoelectric or electro-magnetic driver 80.

According to the embodiment shown in FIG. 4, in addition to the output transducer 46, which then acts as the main output transducer, an auxiliary electromechanical output transducer 48 may be provided at a corresponding port 82 of the box 20 for likewise acting on the perilymph fluid 70 in the central part 66 of the box 20. The auxiliary output transducer 48 may be of the same type as the main output transducer 46 (this variant is shown in FIG. 4) or it may of a different type. Typically, the main output transducer 46 has a maximal output in a first frequency range and the auxiliary output transducer 48 has a maximal output in a second frequency range different from the first frequency range, whereby an optimized frequency response of the output transducers can be realized. The output transducers 46, 48 serve to stimulate the patient's cochlea 24 according to the audio signals captured by the microphone arrangement 26.

According to the embodiment of FIG. 3, the box 20 also comprises a port 84 for receiving an end of the optical fibre 52 for applying optical stimuli to the perilymph fluid 70 in the central part 66 of the box 20 according to the audio signals captured by the microphone arrangement 26.

In the embodiments of FIGS. 3 and 4 the box also is provided with a port 86 for a sensor 88, which senses at least one physical or chemical parameter of the perilymph fluid 70 in the central part 66 of the box 20. For example, the sensor 88 may monitor the pressure and/or impedance of the perilymph fluid 70 or it may be designed for chemical analysis of the perilymph fluid 70, for example for determining the sodium to potassium ion ratio of the perilymph fluid 70.

The sensor 88 is connected electrically via a connection 90 to the unit 42 of the implantable unit 12, which in this case not only serves to receive audio signals from the external unit 10 but to also transmit data provided by the sensor 88 to the external unit, which in this case may comprise an interface 92 for reading such sensor data from the hearing system. Consequently, in this case both the unit 34 and the unit 42 have to be designed as transceiver units.

In the embodiments of FIGS. 3 and 4 the box 20 also comprises a port 94 which comprises a membrane 96 which seals the central part 66 of the box 20. The port 94 may be used for applying drugs into the perilymph fluid 70 of the central part 66 of the box 20 and for taking out perilymph fluid 70 from the central part 66 of the box 20. The drugs may include antibiotics, drugs for treating menengitis and drugs for gene therapy (such as for restoring damaged hair cells). The removed perilymph fluid 70 may be analyzed with regard to infection indicators or the sodium to potassium ion ratio in the fluid 70. In general, analysis of the perilymph fluid 70 may serve to analyze illnesses and to monitor the success of the therapies. An example is the Morbus Meniere, where the potassium-dominated endolymphe is going to be mixed with the sodium-dominated perilymphe due to a break of the Reissner membrane.

As shown in FIG. 2, one option to supply drugs to the port 94 is to connect an implanted drug delivery reservoir 98 via a tube 100 to the port 94. The reservoir 98 may form part, for example, of the implantable unit 12. The tube 100 may be provided with a micro-needle 102 at its end, which may penetrate the membrane 96 of the port 94.

Alternatively, the tympanic membrane 104 may be opened and an external drug delivery device 106, which may have a syringe-type design, may be temporarily connected to the port 94. To this end, the external drug delivery device 106 may be provided with a micro-needle 102.

A similar device may serve as an external fluid removal device 108 including a micro-needle 102, which is temporarily connected to the port 94 after opening the tympanic membrane 104.

Rather than providing the port 94 as a dual purpose port, i.e. serving both for drug application of for removal of perilymph fluid, two separate ports may be provided to this end, one serving only for drug application and the other one serving only for perilymph removal.

1. An at least partially implantable hearing system comprising:
a microphone assembly for capturing audio signals from ambient sound;
an audio signal processing unit for processing the audio signals captured by the microphone assembly;
an implantable main electromechanical output transducer for direct mechanical stimulation of a cochlea according to the audio signals processed by the audio signal processing unit;
an implantable box having a central part and an open flange for penetrating through a cochlear wall into a perilymph fluid, wherein an inner cross section of the central part is larger than an inner cross section of the flange; and wherein the electromechanical output transducer is for acting on the perilymph fluid in the central part of the box through a port provided at the box;
wherein the box further comprises at least one of a port for an implantable auxiliary electromechanical output transducer for acting on the perilymph fluid in the central part of the box, a port for drug application into the perilymph fluid in the central part of the box, a port for taking out perilymph fluid from the central part of the box, a port for applying optical stimuli to the perilymph fluid of the cochlea, and a port for at least one sensor for sensing at least physical or chemical parameter of the perilymph fluid in the central part of the box.

2. The hearing system of claim 1, wherein the port for applying optical stimuli to the perilymph fluid of the cochlea is for coupling an optical fiber to the perilymph fluid in the central part of the box.

3. The hearing system of claim 1, wherein the at least one diagnostic sensor is for monitoring at least one of pressure and impedance of the perilymph fluid in the central part of the box.

4. The hearing system of claim 1, wherein the at least one diagnostic sensor is for chemical analysis of the perilymph fluid in the central part of the box.

5. The hearing system of claim 1, wherein the box comprises a metallic, ceramic or plastic housing.

6. The hearing system of claim 1, wherein the main output transducer has a maximal output in a first frequency range and the auxiliary output transducer has a maximal output in a second frequency range different from the first frequency range.

7. The hearing system of claim 1, wherein at least one of the main output transducer and the auxiliary output transducer comprises a driven piston or a driven membrane for acting on the perilymph fluid in the central part of the box.

8. The hearing system of claim 1, wherein at least one of the main output transducer and the auxiliary output transducer comprise a piezoelectric or electromagnetic driver.

9. The hearing system of claim 1, wherein the port for drug application is also for taking out perilymph fluid from the central part of the box and comprises a membrane which seals the central part of the box.

10. The hearing system of claim 1, wherein the system comprises an implantable drug reservoir having a tube extending to the port for drug application.

11. The hearing system of claim 1, wherein the microphone assembly and the audio signal processing unit form part of an external unit, wherein the processed audio signals are supplied to the electromechanical output transducer via a wireless transcutaneous link.

12. (canceled)

13. The method of claim 24, wherein the fixing of the box at the cochlear wall is performed using glue, bone cement, clamps or screws.

14. The method of claim 24, further comprising screwing the flange of the box into the opening in the cochlear wall.

15. The method of claim 24, wherein the opening in the cochlea wall is created by stapedectomy, stapedotomy, cochleostomy or removing the round window.

16. The method of claim 14, further comprising applying a drug through the port for drug application into the perilymph fluid by opening a tympanic membrane of a patient and connecting an external drug delivery device to the port for drug application.

17. The method of claim 16, wherein the external drug delivery device comprises a micro-needle for penetrating a membrane of the drug application port.

18. The method of claim 16, wherein the external drug delivery device has a syringe-type design.

19. The method of claim 16, wherein applied drugs comprise at least one of antibiotics, drugs for treating meningitis and drugs for gene therapy.

20. The method of claim 24, further comprising taking the periplymph fluid out through the perilymph taking-out port by opening a tympanic membrane of a patient and connecting an external fluid removal device to the perilymph taking-out port.

21. The method of claim 20, wherein the external fluid removal device comprises a micro-needle for penetrating a membrane of the perilymph taking-out port.

22. The method of claim 20, wherein the external fluid removal device has a syringe-type design.

23. The method of claim 20, further comprising analyzing the removed perilymph fluid regard to at least one of infections and the sodium to potassium ion ratio.

24. A method comprising:
connecting an implantable main electromechanical output transducer to a port that is a part of an implantable box, the implantable main electromechanical output transducer configured to provide direct mechanical stimulation of a cochlea in accordance with audio signals processed by an audio signal processing unit, the implantable box having a central part and an open flange for penetrating through a cochlear wall into a perilymph fluid, wherein an inner cross section of the central part is larger than an inner cross section of the flange;
creating an opening in a wall of the cochlea;
inserting the flange of the box into the opening; and
fixing the box at the cochlear wall.
